(19) United States
(12) Patent Application Publication
(10) Pub. No.: US 2011/0090284 A1
(43) Pub. Date: Apr. 21, 2011

(54) Printing Apparatus, Discharge Inspecting Apparatus and Discharge Inspecting Method

(75) Inventor: Sukehiro Ito, Nagano-ken (JP)

(73) Assignee: SEIKO EPSON CORPORATION, Tokyo (JP)

(21) Appl. No.: 12/902,963

(22) Filed: Oct. 12, 2010

(30) Foreign Application Priority Data
Oct. 19, 2009 (JP) 2009-240691

(51) Int. Cl. B41J 2/135

(52) U.S. Cl. 347/44

(57) ABSTRACT

The printing apparatus includes: a head which discharges liquid from a nozzle and is grounded; a detection electrode which is opposed to the nozzle at a predetermined interval and is sealed by an insulating member; a power source which ensures the detection electrode is at a predetermined potential; a determining unit which detects a change in potential of the detecting electrode that is caused by the discharge of the liquid from the nozzle and determines a nozzle that does not normally discharge the liquid to the head on the basis of the change in potential of the detection electrode; and a cap portion which abuts the head during non-printing and accommodates the detection electrode.

### CROSS-REFERENCE TO RELATED APPLICATION

Japanese Patent Application No. 2009-240691 is hereby incorporated by reference in its entirety.

### BACKGROUND

1. Technical Field

The present invention relates to a printing apparatus, a discharge inspecting apparatus and a discharge inspecting method.

2. Related Art

In a printer for forming an image by discharging ink, there may be a case where the ink is not discharged from a nozzle and a desired image cannot be obtained. In order to detect such an inconvenience, a sensor for determining whether or not ink is suitably discharged from a nozzle has been developed. In JP-A-2003-53949, a sensor configured by integrating a printed circuit board and an ink droplet sensing element is disclosed.

As a technique for determining whether or not ink is discharged from nozzles, there is a method of detecting a change in potential of a detection electrode which is caused due to discharge of liquid from the nozzles by applying a potential difference between the nozzle and the detection electrode. In this detection technique, the potential difference between the nozzle and the detection electrode has to be provided. However, when the potential difference is applied, there is a problem in that current may leak from the detection electrode. Therefore, in a discharge inspecting apparatus, it is preferable that leakage of current from the detection electrode is suppressed.

### SUMMARY

An advantage of some aspects of the invention is to suppress leakage of current from a detection electrode in a discharge inspecting apparatus.

According to an aspect of the invention, there is provided a discharge inspecting apparatus including: a head which discharges liquid from a nozzle and is grounded; a detection electrode which is opposed to the nozzle at a predetermined interval and is sealed by an insulating member; a power source which ensures the detection electrode is at a predetermined potential; a determining unit which detects a change in potential of the detecting electrode that is caused by the discharge of the liquid from the nozzle and determines a nozzle that does not normally discharge the liquid to the head on the basis of the change in potential of the detection electrode; and a cap portion which abuts the head during non-printing and accommodates the detection electrode.

Further features of the invention will become apparent from the following description of the specifications and the accompanying drawings.

### BRIEF DESCRIPTION OF THE DRAWINGS

The invention will be described with reference to the accompanying drawings, wherein like numbers reference like elements.

FIG. 1A is a block diagram for explaining a printing system having a printer and a computer, and FIG. 1B is a perspective view of the printer.

FIG. 2A is a cross-sectional view of the head, and FIG. 2B is a diagram illustrating an array of nozzles provided in a nozzle plate.

FIGS. 3A to 3C are diagrams illustrating a positional relationship between the head and a cap mechanism during a recovering operation.

FIG. 4 is a diagram of a cap viewed from above.

FIG. 5A is a diagram for explaining a dot skip detecting unit, and FIG. 5B is a block diagram for explaining a detection control unit.

FIG. 6A is a diagram illustrating an example of a driving signal used for discharge inspection, FIG. 6B is a diagram for explaining a voltage signal output from an amplifier when ink is discharged from the nozzles by the driving signal, and FIG. 6C is a diagram illustrating a voltage signal which is a discharge inspection result of a plurality of nozzles.

FIG. 7 is a transverse cross-sectional view of the cap according to an embodiment.

FIG. 8 is a transverse cross-sectional view of the cap according to another embodiment.

### DESCRIPTION OF EXEMPLARY EMBODIMENTS

At least the following features will become apparent from the description of the specification and the accompanying drawings.

There is provided a discharge inspecting apparatus including: a head which discharges liquid from a nozzle and is grounded; a detection electrode which is opposed to the nozzle at a predetermined interval and is sealed by an insulating member; a power source which ensures the detection electrode is at a predetermined potential; a determining unit which detects a change in potential of the detecting electrode that is caused by the discharge of the liquid from the nozzle and determines a nozzle that does not normally discharge the liquid to the head on the basis of the change in potential of the detection electrode; and a cap portion which abuts the head during non-printing and accommodates the detection electrode.

Accordingly, even when the detection electrode is at a high potential, leakage of current from the detection electrode can be suppressed. In addition, the nozzle that does not discharge liquid can be suitably determined.

In the discharge inspecting apparatus, the cap portion may accommodate the determining unit. As the determining unit is accommodated in the cap portion, distance between the detection electrode and the determining unit can be reduced. Therefore, a voltage applied to the detection electrode can be a relatively low voltage.

In addition, in the cap portion, the determining unit may be sealed so that the liquid does not reach an inside of the determining unit. As the determining unit is sealed, the liquid does not penetrate into the determining unit, so that the determining unit can be accommodated in the cap portion.

In addition, the determining unit may be a circuit board configured by integrating a circuit and a board, and the circuit board may be accommodated in the cap portion so that the board side is opposed to the head. Accordingly, the detection electrode is provided on the reverse side of the board to the side on which the circuit is formed.

In addition, the determination of the nozzle that does not discharge liquid may be performed on the basis of a signal indicating a change in electrostatic capacitance. Accordingly, on the basis of the electrostatic capacitance that varies as the liquid is discharged from the head, the nozzle that does not normally discharge the liquid can be determined.

In addition, the head may include a nozzle plate having a plurality of the nozzles, and the nozzle plate may be grounded. Accordingly, on the basis of the electrostatic capacitance that varies as the liquid is discharged from the nozzles of the nozzle plate, the nozzle that does not normally discharge the liquid can be determined.

In addition, the case that the liquid is not normally discharged may include a case where an amount of the liquid discharged is smaller than a predetermined amount. Accordingly, a case where a smaller amount of the liquid than an amount to be originally discharged is discharged can be detected.

There is provided a printing apparatus including: a head which discharges liquid from a nozzle and is grounded; a detection electrode which is opposed to the nozzle at a predetermined interval and is sealed by an insulating member; a power source which ensures the detection electrode is at a predetermined potential; a determining unit which detects a change in potential of the detecting electrode that is caused by the discharge of the liquid from the nozzle and determines a nozzle that does not normally discharge the liquid to the head on the basis of the change in potential of the detection electrode; and a cap portion which abuts the head during non-printing and accommodates the detection electrode.

Accordingly, even when the detection electrode is at a high potential, leakage of current from the detection electrode can be suppressed. In addition, the nozzle that does not discharge liquid can be suitably determined.

### Ink Jet Printer

An embodiment will be described by exemplifying an ink jet printer (hereinafter, a printer 1) as a printing apparatus.

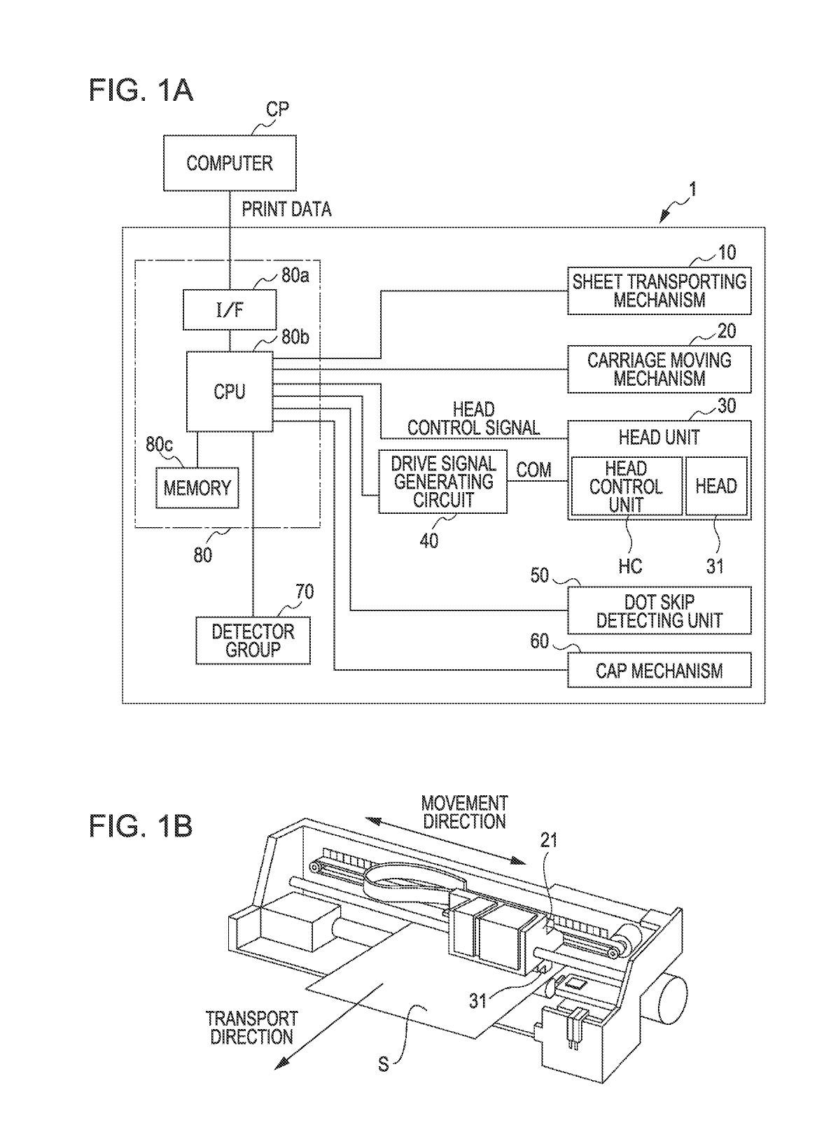

FIG. 1A is a block diagram for explaining a printing system having a printer 1 and a computer CP, and FIG. 1B is a perspective view of the printer 1. The printer 1 discharges ink which is a kind of liquid toward a medium such as a sheet, fabric, or film. The computer CP is connected to the printer 1 so as to be able to communicate. In order to allow the printer 1 to print an image, the computer CP transmits print data corresponding to the image to the printer 1. The printer 1 includes a sheet transporting mechanism 10, a carriage moving mechanism 20, a head unit 30, a drive signal generating circuit 40, a dot skip detecting unit 50, a cap mechanism 60, a detector group 70, and a controller 80.

The sheet transporting mechanism 10 transports a sheet in a transport direction. The carriage moving mechanism 20 moves a carriage 21 to which the head unit 30 is mounted in a movement direction (a direction intersecting the transport direction).

The head unit 30 includes a head 31 and a head control unit HC. The head 31 discharges ink toward the sheet. The head control unit HC controls the head 31 on the basis of a head control signal transmitted from the controller 80 of the printer 1.

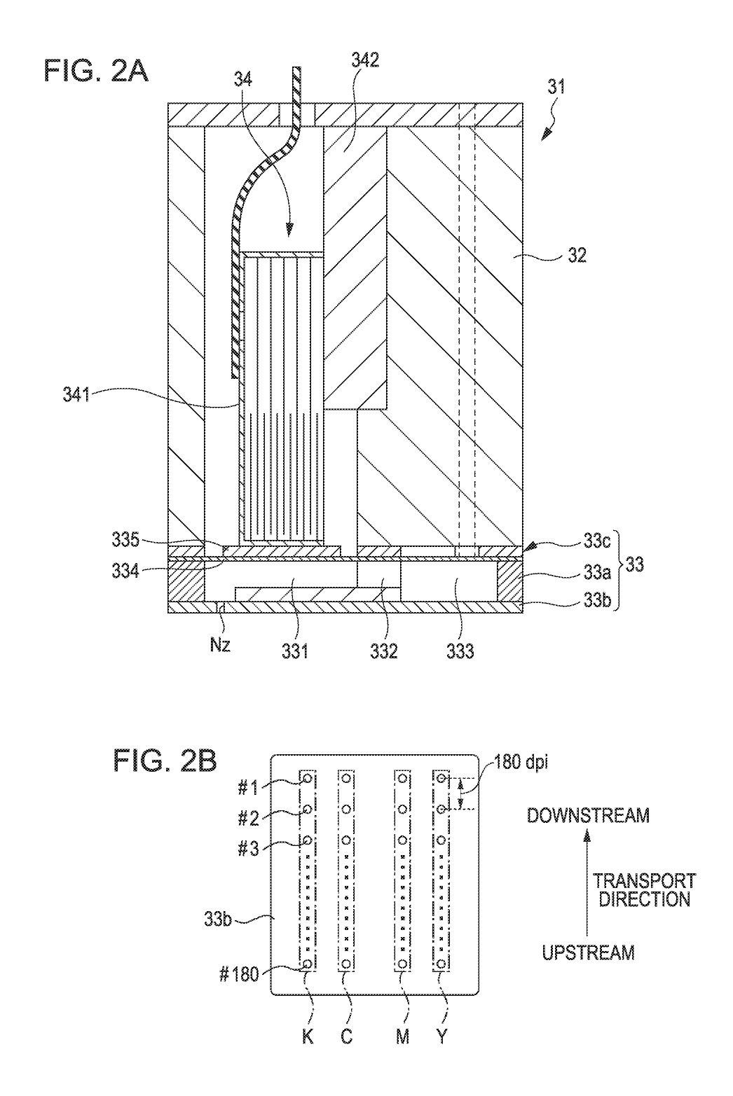

FIG. 2A is a cross-sectional view of the head 31. The head 31 includes a case 32, a flow path unit 33, and a piezo element unit 34. The case 32 is a member for accommodating and fixing piezo elements PZT or the like, and is manufactured using a nonconductive resin material such as an epoxy resin.

The flow path unit 33 includes a flow path formation substrate 33a, a nozzle plate 33b, and a vibration plate 33c. The nozzle plate 33b is joined to one surface of the flow path formation substrate 33a, and the vibration plate 33c is joined to the other surface thereof. A pressure chamber 331, an ink supplying path 332, and a common ink chamber 333 which are configured as empty spaces and grooves are provided in the flow path formation substrate 33a. The flow path formation substrate 33a is formed of, for example, a silicon substrate. A nozzle group including a plurality of nozzles Nz is provided in the nozzle plate 33b. The nozzle plate 33b is formed of a plate-like material having conductivity, such as a thin metal plate. In addition, the nozzle plate 33b is connected to a ground line having a ground potential. A portion of the vibration plate 33c corresponding to the pressure chamber 331 is provided with a diaphragm portion 334. The diaphragm portion 334 is deformed by piezo elements PZT and changes the volume of the pressure chamber 331. In addition, the piezo elements PZT and the nozzle plate 33b are electrically insulated from each other by the vibration plate 33c or an adhesive layer interposed therebetween.

The piezo element unit 34 has a piezo element group 341 and a fixed plate 342. The piezo element group 341 has a pectinate shape. Here, each single tooth of the pectinate shape is the piezo element PZT. A front end surface of each piezo element PZT is adhered to an insular portion 335 that the corresponding diaphragm portion 334 has. The fixed plate 342 supports the piezo element group 341 and serves as a portion mounted to the case 32. The piezo element PZT is a kind of electro-mechanical conversion element, elongates or contracts in a longitudinal direction as a drive signal COM is applied, and causes a change in the pressure of the liquid inside the pressure chamber 331. A change in the pressure of the ink inside the pressure chamber 331 occurs as the volume of the pressure chamber 331 is changed. Ink droplets are discharged from the nozzles Nz using the change in pressure.

FIG. 2B is a diagram illustrating an array of the nozzles Nz provided in the nozzle plate 33b. In the nozzle plate 33b, a plurality of nozzle rows is provided in which 180 nozzles #1 to #180 are lined up at an interval of 180 dpi along a transport direction of a sheet. Each nozzle row discharges ink with a different color, and four nozzle rows are provided in the nozzle plate 33b. Specifically, there are a black ink nozzle row K, a cyan ink nozzle row C, a magenta ink nozzle row M, and a yellow ink nozzle row Y.

The drive signal generating circuit 40 generates the drive signal COM. As the drive signal COM is applied to the piezo element PZT, the piezo element PZT elongates or contracts such that the volume of the pressure chamber 331 corresponding to each nozzle Nz is changed. Therefore, the drive signal COM is applied to the head 31 during printing, dot skip inspection (described later), flushing which is a recovering operation of the nozzle Nz that skips a dot, and the like.

The dot skip detecting unit 50 detects whether or not ink is discharged from each nozzle Nz. The cap mechanism 60 performs a suction operation for sucking ink from each nozzle Nz to suppress an ink solvent from evaporating in the nozzles Nz or for recovering the discharging ability of the nozzles Nz. The detector group 70 includes a plurality of detectors for monitoring the status of the printer 1. The detection result from the detectors is output to the controller 80.

The controller 80 controls the entire printer 1 and has an interface unit 80a, a CPU 80b, and a memory 80c. The interface unit 80a transceiver data with the computer CP. The memory 80c ensures an area for storing computer programs, a work area, and the like. The CPU 80b controls units to be controlled (the sheet transporting mechanism 10, the carriage moving mechanism 20, the head unit 30, the drive signal generating circuit 40, the dot skip detecting unit 50, the cap mechanism 60, and the detector group 70) according to the computer programs stored in the memory 80c.

In the printer 1, a dot forming process for intermittently discharging ink from the head 31 which moves along the movement direction of the carriage and forming dots on the sheet and a transporting process for transporting the sheet in the transport direction are repeatedly performed. As a result, dots are formed at positions different from positions of dots formed by the preceding dot formation process thereby printing a two-dimensional image on a medium.

### Discharge Inspection (Overview) and Recovering Operation

When ink (liquid) is not discharged from the nozzles for a long time or foreign matter such as paper powder is adhered to the nozzles, the nozzles may clog. When the nozzles clog, a phenomenon occurs in which ink is not discharged when ink has to be discharged from the nozzles and a dot is not formed at a point where the dot has to be formed (dot skip). When the “dot skip” occurs, image quality is degraded. Therefore, in this embodiment, when a dot skip nozzle is detected as a result of “discharge inspection” by the dot skip detecting unit 50, the “recovering operation” is performed to normally discharge ink from the dot skip nozzle.

Here, the dot skip inspection may be performed immediately after the printer 1 is turned on or when the printer 1 receives print data from the computer CP and starts printing. In addition, the dot skip inspection may be performed at a predetermined time interval during printing which is performed for a long time. Hereinafter, the recovering operation of the dot skip nozzle will be described, and next, the discharge inspection (overview) will be described.

### Recovering Operation

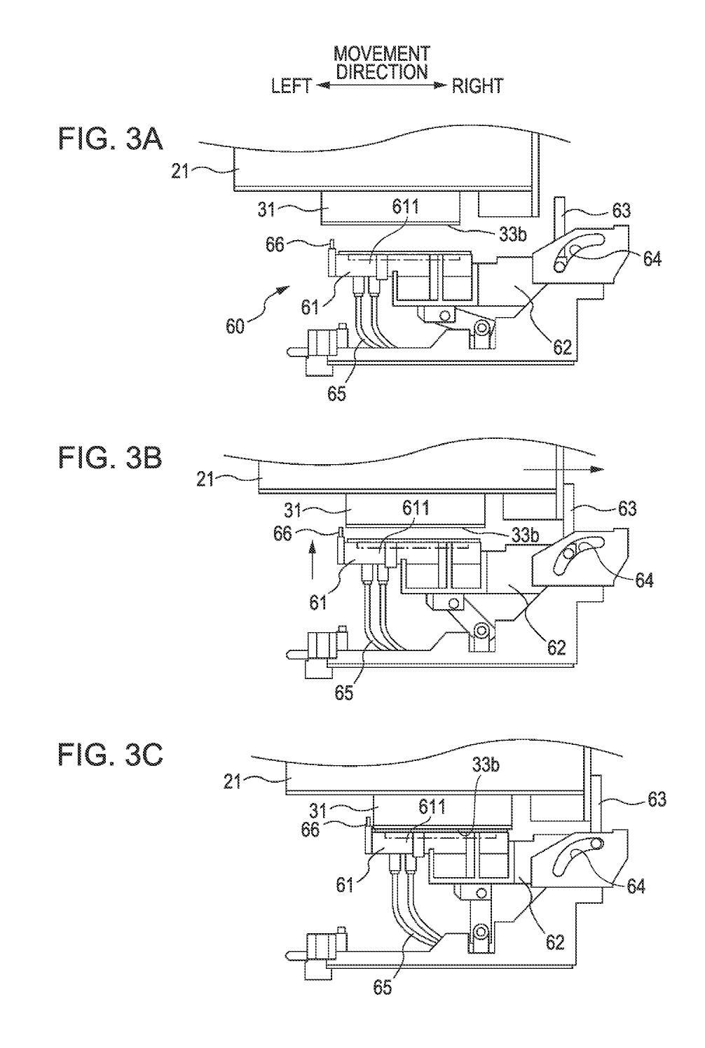

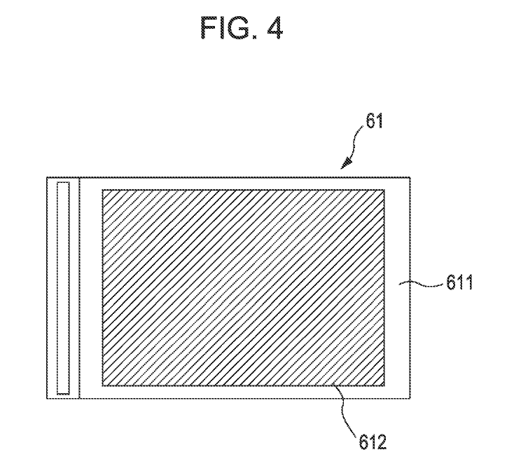

FIGS. 3A to 3C are diagrams illustrating a positional relationship between the head 31 and the cap mechanism 60 during the recovering operation. First, the cap mechanism 60 is described. The cap mechanism 60 includes a cap 61 and a slider member 62 which supports the cap 61 and is movable in an oblique vertical direction. The cap 61 is formed in a thin box shape having a rectangular bottom portion (not shown), a side wall portion 611 standing from a periphery of the bottom portion and a top surface which opposes the nozzle plate 33b and is open. In a space surrounded by the bottom portion and the side wall portion 611, a sheet-like moisturizing member is disposed which is formed of a porous member such as felt or a sponge. An internal configuration of the cap 61 will be described later.

As illustrated in FIG. 3A, in a state where the carriage 21 is separated from a home position (here, on the right in the movement direction), the cap 61 is placed at a position sufficiently lower than the surface of the nozzle plate 33b (hereinafter, referred to as a nozzle surface). In addition, as illustrated in FIG. 3B, as the carriage 21 moves toward the home position, the carriage 21 abuts against an abutting portion 63 provided in a slider member 62, and the abutting portion 63 moves toward the home position along with the carriage 21. When the abutting portion 63 moves toward the home position, the slider member 62 ascends along a long guidance hole 64, and thus the cap 61 also ascends. Finally, as illustrated in FIG. 3C, as the carriage 21 is placed at the home position, the side wall portion 611 of the cap 61 comes in close contact with the nozzle plate 33b. Accordingly, when power is turned off or during a long interruption, by placing the carriage 21 at the home position, evaporation of the ink solvent in the nozzle can be suppressed.

Next, the recovering operation will be described. As the recovering operation of the dot skip nozzle, there is a “flushing operation”. As illustrated in FIG. 3B, the flushing operation is an operation of solving the clogging of the nozzle by forcefully and continuously discharging ink droplets from each nozzle in a state where a small gap is opened between the nozzle surface and the periphery of the opening of the cap 61.

In addition, a waste liquid tube 65 is connected to a space between the bottom surface of the cap 61 and the side wall portion 611, and a suction pump (not shown) is connected to the path of the waste liquid tube 65. As another recovering operation, as illustrated in FIG. 3C, in the state where the periphery of the opening of the cap 61 abuts against the nozzle surface, “pump suction” is performed. As the suction pump is operated in the state where the side wall portion 611 of the cap 61 comes in close contact with the nozzle surface, the space of the cap 61 can be applied with a negative pressure. Accordingly, the ink in the head 31 can be sucked along with thickened ink and paper powder, thereby recovering the dot skip nozzle.

Also, by moving the carriage 21 in the movement direction while maintaining the cap mechanism 60 at the position illustrated in FIG. 3B, ink droplets or foreign matter adhered to the nozzle surface are removed using a wiper 66 projecting higher than the side wall portion 611 of the cap 61. As a result, ink can be normally discharged from the nozzles clogged by the foreign matter.

### Dot Skip Detecting Unit 50

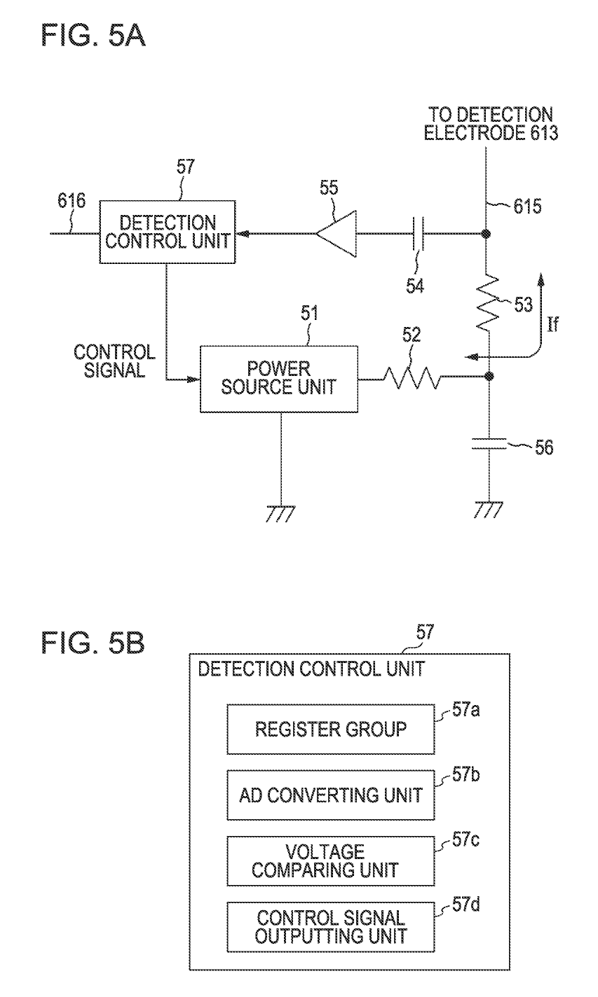

FIG. 4 is a diagram of the cap 61 viewed from above, FIG. 5A is a diagram for explaining the dot skip detecting unit 50, and FIG. 5B is a block diagram for explaining a detection control unit 57. The dot skip detecting unit 50 detects a nozzle that skips a dot by allowing each nozzle to actually discharge ink and determining whether or not ink is normally discharged. First, a configuration of the dot skip detecting unit 50 will be described. As illustrated in FIG. 5A, the dot skip detecting unit 50 includes a power source unit 51, a first limiting resistor 52, a second limiting resistor 53, a detection condenser 54, an amplifier 55, a smoothing condenser 56, and the detection control unit 57.

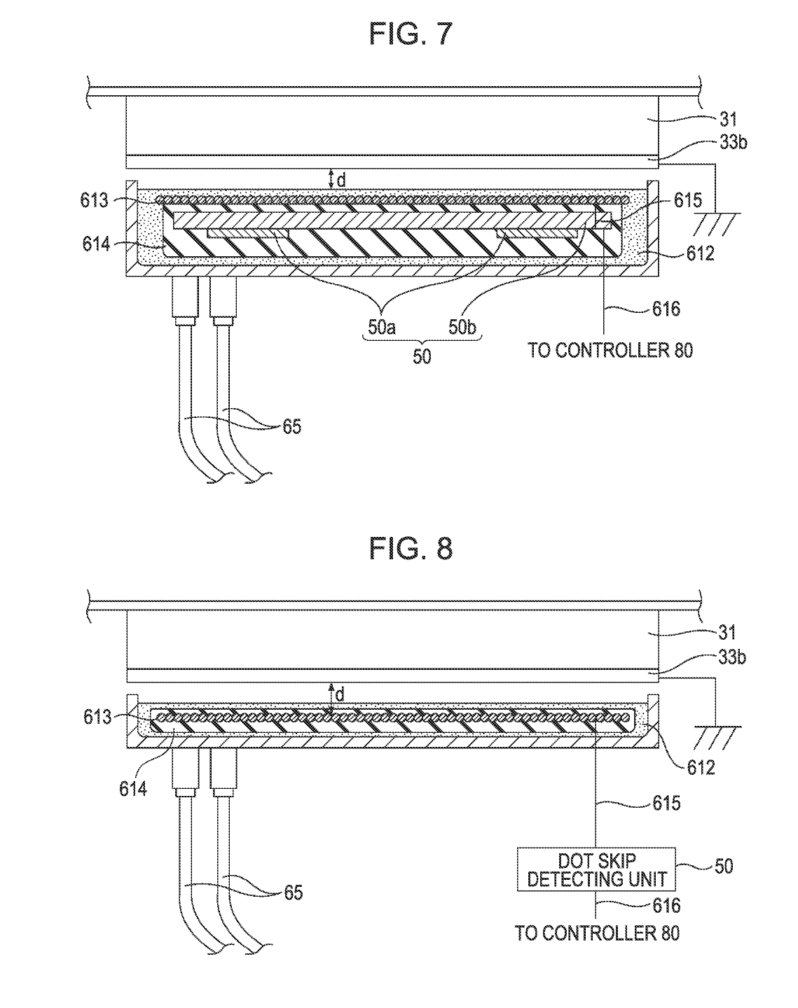

A moisturizing member 612 is disposed in the space surrounded by the side wall portion 611 of the cap 61 is, as illustrated in FIG. 4. In addition, a detection electrode 613 is provided in the cap 61, and the nozzle surface and the detection electrode 613 are opposed at a predetermined interval d during dot skip detection as illustrated in FIG. 7. The detection electrode 613 has a potential of about 42 V during the dot skip detection operation. The detection electrodes 613 are provided in a planar shape in the cap 61, and in this structure, they are evenly charged over a wide range.

The power source unit 51 is a kind of power source for ensuring that the detection electrode 613 in the cap 61 has a predetermined potential. The power source unit 51 in this embodiment is configured by a DC power source of about 42 V such that the operations thereof are controlled by a control signal from the detection control unit 57.

The first and second limiting resistors 52 and 53 are disposed between an output terminal of the power source unit 51 and the detection electrode 613 to limit current flowing between the power source unit 51 and the detection electrode 613. In this embodiment, the first and second limiting resistors 52 and 53 have the same resistance and are connected in series. As illustrated in the figures, one end of the first limiting resistor 52 is connected to the output terminal of the power source unit 51, the other end thereof is connected to one end of the second limiting resistor 53, and the other end of the second limiting resistor 53 is connected to the detection electrode 613.

The detection condenser 54 is an element for extracting a potential change component of the detection electrode 613 and has one conductor connected to the detection electrode 613 and the other conductor connected to the amplifier 55. By interposing the detection conductor 54 therebetween, a bias component (DC component) of the detection electrode 613 can be removed, thereby signal handling can be easily performed.

The amplifier 55 amplifies and outputs a signal (change in potential) exhibiting at the other end of the detection condenser 54. Accordingly, the potential change component can be acquired as a voltage signal having a variation width of about 2 to 3 V. A set of the detection condenser 54 and the amplifier 55 corresponds to a kind of detector and detects an electrical change in the detection electrode 613 caused by the discharge of ink droplets.

The smoothing condenser 56 suppresses a sharp change in potential. The one end of the smoothing condenser 56 in this embodiment is connected to a signal line connecting the first and second limiting resistors 52 and 53 with each other, and the other end thereof is connected to the ground.

The detection control unit 57 is a unit for controlling the dot skip detecting unit 50. As illustrated in FIG. 5B, the detection control unit 57 includes a resistor group 57a, an AD converting unit 57b, a voltage comparing unit 57c, and a control signal outputting unit 57d. The resistor group 57a includes a plurality of resistors. Each resistor stores the determination result of the nozzles Nz, a voltage threshold for the determination, and the like. The AD converting unit 57b converts an amplified voltage signal (analog value) output from the amplifier 55 into a digital value. The voltage comparing unit 57c compares an amplitude value with the voltage threshold on the basis of the amplified voltage signal. The control signal outputting unit 57d outputs a control signal for controlling the operation of the power source unit 51.

### Overview of Discharge Inspection

In the printer 1, the nozzle plate 33b is connected to the ground to have a ground potential, and the detection electrode 613 disposed in the cap 61 has a potential of about 42 V. Ink droplets discharged from the nozzles have the ground potential by the nozzle plate having the ground potential. The nozzle plate 33b and the detection electrode 613 are opposed at the predetermined interval d (see FIG. 7) to discharge ink droplets from the nozzle to be detected. In addition, an electrical change in the detection electrode 613 due to the discharge of the ink droplets is acquired by the detection control unit 57 as a voltage signal SG via the detection condenser 54 and the amplifier 55. The detection control unit 57 determines whether or not ink droplets are normally discharged from the nozzle to be detected on the basis of the amplitude value (potential change) of the voltage signal SG.

The principle of the detection is based on the nozzle plate 33b and the detection electrode 613 disposed at the predetermined interval d acting as a condenser. As illustrated in FIG. 7, due to the contact with the nozzle plate 33b connected to the ground, ink (ink column) elongating in a columnar shape from the nozzle Nz has the ground potential. It is thought that the elongation of the ink changes an electrostatic capacitance in the condenser. That is, as ink is discharged from the nozzle, the ink at the ground potential and the detection electrode 613 configure a condenser and thus the electrostatic capacitance is changed.

In addition, as the electrostatic capacitance becomes smaller, an amount of charge that can be stored between the nozzle plate 33b and the detection electrode 613 is reduced. Accordingly, redundant charge moves toward the power source unit 51 from the detection electrode 613 through the limiting resistors 52 and 53. That is, current flows toward the power source unit 51. On the other hand, when the electrostatic capacitance is increased or the reduced electrostatic capacitance is recovered, charge moves toward the detection electrode 613 from the power source unit 51 through the limiting resistors 52 and 53. That is, current flows toward the detection electrode 613. As the current (for convenience, referred to as discharge inspection current If) flows, the potential of the detection electrode 613 is changed. The change in potential of the detection electrode 613 is shown as the potential change in the other conductor (the conductor on the amplifier 55 side) of the detection condenser 54. Therefore, by monitoring the potential change in the other conductor, whether or not ink droplets are discharged can be determined.

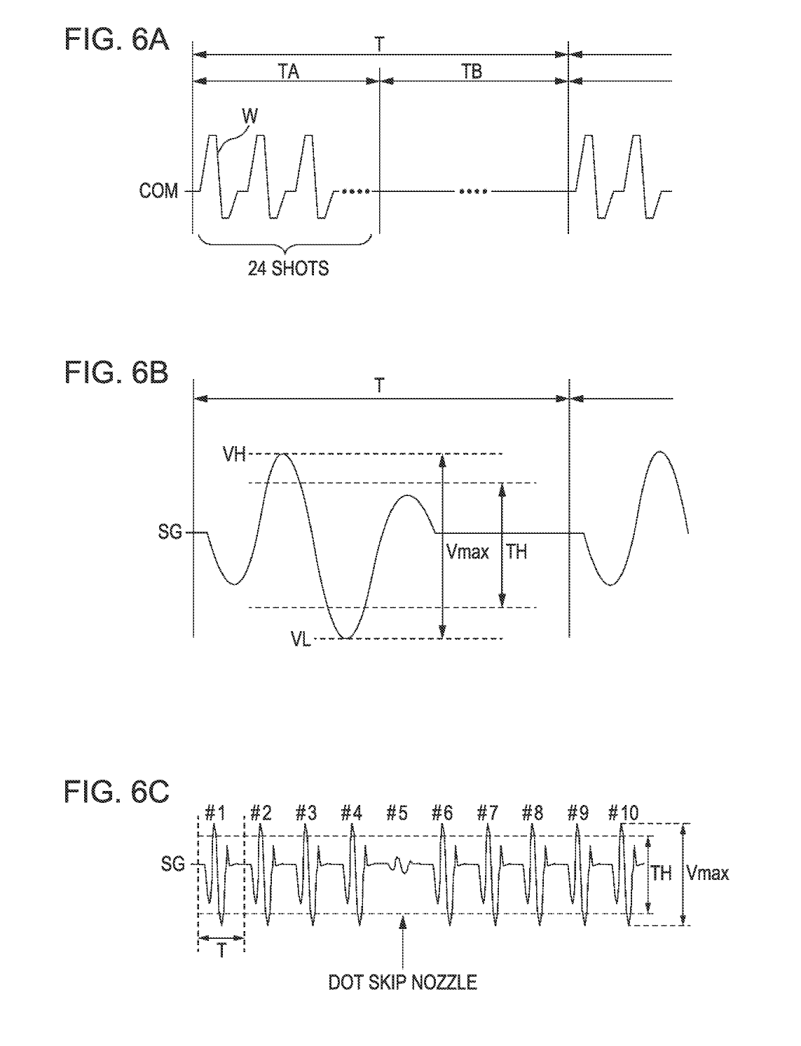

FIG. 6A is a diagram illustrating an example of the driving signal COM used for the discharge inspection, FIG. 6B is a diagram for explaining the voltage signal SG output from the amplifier 55 when ink is discharged from the nozzles by the driving signal COM of FIG. 6A, and FIG. 6C is a diagram illustrating the voltage signal SG which is a discharge inspection result of a plurality of nozzles (#1 to #10). The drive signal COM has a plurality of (for example, 24) drive waveforms W for discharging ink from the nozzle in the first half period TA of a repetition period T and maintains a constant potential at an intermediate potential in the second half period TB. The drive signal generating circuit 40 repeatedly generates the plurality of drive waveforms W (24 drive waveforms) per repetition period T. The repetition period T corresponds to time needed to inspect a single nozzle.

First, the drive signal COM is applied over the repetition period T to the piezo element corresponding to a certain nozzle to be inspected. Then, ink droplets are continuously discharged from the nozzle which is an object of the discharge inspection in the first half period TA (for example, 24 shots). Accordingly, the potential of the detection electrode 613 is changed, and the amplifier 55 outputs the potential change to the detection control unit 57 as the voltage signal SG (sign curve) illustrated in FIG. 6B. Moreover, since the amplitude of the voltage signal SG by one shot of ink droplet is small, the ink droplets are continuously discharged from the nozzle to obtain the voltage signal SG having sufficient amplitude for the inspection.

The detection control unit 57 calculates a maximum amplitude Vmax (a difference between a maximum voltage VH and a minimum voltage VL) from the voltage signal SG of the inspection period (T) of the nozzle to be inspected and compares the maximum amplitude Vmax with a predetermined threshold TH. When ink is discharged from the nozzle to be inspected in response to the drive signal COM, the potential of the detection electrode 613 is changed, and the maximum amplitude Vmax of the voltage signal SG becomes greater than the threshold TH. On the other hand, when ink is not discharged from the nozzle to be inspected due to clogging or an amount of ink discharged is small, the potential of the detection electrode 613 may not be changed, or the potential change is small. In this case, the maximum amplitude Vmax of the voltage signal SG becomes equal to or smaller than the threshold TH.

After applying the drive signal COM to the piezo element corresponding to the certain nozzle, the drive signal COM is applied to the piezo element corresponding to the nozzle to be inspected subsequently over the repetition period T. As such, for each nozzle to be inspected, the drive signal COM is applied to the piezo element of the corresponding nozzle over the repetition period T. As a result, the detection control unit 57 acquires the voltage signal SG generating the potential change as a sine curve for each of the repetition period T as illustrated in FIG. 6C.

For example, according to the result of FIG. 6C, since the maximum amplitude Vmax of the voltage signal SG corresponding to an inspection period of the nozzle #5 is smaller than the threshold TH, the detection control unit 57 determines that the nozzle #5 is the dot skip nozzle. Since the maximum amplitudes Vmax of the voltage signals SG corresponding to inspection periods of other nozzles #1 to #4 and #6 to #10 are equal to or greater than the threshold TH, the detection control unit 57 determines that the other nozzles are normal nozzles. When the dot skip nozzle is detected by the dot skip detecting unit 50 as described above, the controller 80 of the printer 1 performs the recovering operation on the head 31. As a result, an image with high image quality and without skipped dots can be printed.

### Configuration of Cap 61 in this Embodiment

FIG. 7 is a transverse cross-sectional view of the cap 61 according to this embodiment. Hereinafter, the internal configuration of the cap 61 will be described with reference to the figure.

The cap 61 includes the detection electrode 613, the moisturizing member 612 (corresponding to a liquid absorbing member), an insulating member 614, and the dot skip detecting unit 50 (corresponding to a determining unit) therein.

The dot skip detecting unit 50 includes a circuit 50a and a board 50b. In addition, as described above, the detection electrode 613 in a wire shape is provided in the cap 61. The detection electrodes 613 are surrounded by the cap 61 in the planar shape, and in this structure, they are evenly charged over the wide range. In addition, the detection electrodes 613 are sealed by the insulating member 614. In addition, the circuit 50a and the board 50b are also sealed by the insulating member 614. The insulating member 614 is an insulator such as rubber.

As described above, the moisturizing member 612 is disposed on the periphery of the insulating member 614 which seals the dot skip detecting unit 50 and the detection electrode 613. As the moisturizing member 612 is disposed as described above, ink that may scatter during the recovering operation of the nozzle is absorbed by the moisturizing member 612.

The electrode 613 is insulated by the insulating member 614 to prevent the leakage of current from the electrode 613. In addition, the circuit 50a and the board 50b are insulated by the insulating member 614 to prevent a short circuit due to the ink discharged to the moisturizing member 612.

The detection electrode 613 and wiring of the circuit 50a configured in the board 50b are connected to each other with a connection line 615 that penetrates the board 50b and the insulating member 614. In addition, the wiring of the circuit 50a configured in the board 50b and the controller 80 are connected to each other with a connection line 616 that penetrates the insulating member 614, the moisturizing member 612, and the side wall portion 611. The detection electrode 613 is provided on a rear surface side of the board 50b. Accordingly, the detection electrode 613 is provided on the reverse side to the circuit 50a side of the board 50b, so that a module including the detection electrode 613, the dot skip detection unit 50, and the like can be configured to be more compact.

With the configuration described above, from the head 21 side, the moisturizing member 612, the insulating member 614, the detection electrode 613, the insulating member 614, the board 50b, the circuit 50a, the insulating member 614, and the moisturizing member 612 are arranged in this order and accommodated in the cap 61.

According to the related art, the dot skip detecting unit 50 is not embedded in the cap 61 but provided outside the cap 61. In this case, the detecting unit 50 and the detection electrode 613 are connected with a member such as a harness. However, due to the effect of the harness, a signal may not be suitably obtained. Therefore, in order to suitably obtain the voltage signal SG, the voltage applied to the detection electrode 613 has to be at a level of 600 V to 1 kV, resulting in an increase in size of the power source unit. Therefore, there is a problem in that the printer 1 itself has to be increased in size.

For this, in the configuration of the cap 61 of this embodiment, the detection electrode 613 and the dot skip detecting unit 50 are accommodated inside the cap 61 such that a distance therebetween is reduced. Therefore, the connection member such as the harness is not needed, so that dot skipping can be suitably detected even at a voltage lower than the voltage applied to the detection electrode 613.

### Other Embodiments

FIG. 8 is a transverse cross-sectional view of the cap 61 according to another embodiment. In the above-described embodiment, the dot skip detecting unit 50 is provided inside the cap 61. However, the dot skip detecting unit 50 may be provided outside the cap 61 as long as the detection electrode 613 is sealed by the insulating member 614 and provided inside the cap 61. In this case, a voltage higher than 42 V may be applied to the detection electrode.

In the above-described embodiment, the printer 1 is exemplified as the printing apparatus. However, the invention is not limited thereto, and a liquid discharging apparatus for ejecting or discharging fluid other than ink (liquid, a liquid material in which particles of a functional material are dispersed, or a fluid material such as gel) may be implemented. For example, techniques as described in this embodiment may be applied to various apparatus applying ink jet techniques such as a color filter manufacturing apparatus, a dyeing apparatus, a microfabrication apparatus, a semiconductor manufacturing apparatus, a surface machining apparatus, a three-dimensional modeling device, a gas vaporizing apparatus, an organic EL manufacturing apparatus (particularly a high-polymer EL manufacturing apparatus), a display manufacturing apparatus, a film forming apparatus, and a DNA chip manufacturing apparatus. In addition, such methods and manufacturing methods are included in the application range.

The embodiments are provided for easy understanding of the invention and are not intended to limit the invention. Modifications and Improvements can be made without departing from the spirit and scope of the invention, and it is needless to say that equivalent matters are included in the invention.

What is claimed is:

1. A printing apparatus comprising:
a head which discharges liquid from a nozzle and is grounded;
a detection electrode which is opposed to the nozzle at a predetermined interval and is sealed by an insulating member;
a power source which ensures the detection electrode is at a predetermined potential;
a determining unit which detects a change in potential of the detecting electrode that is caused by the discharge of the liquid from the nozzle and determines a nozzle that does not normally discharge the liquid to the head on the basis of the change in potential of the detection electrode; and
a cap portion which abuts the head during non-printing and accommodates the detection electrode.

2. The printing apparatus according to claim 1, wherein the cap portion accommodates the determining unit.

3. The printing apparatus according to claim 2, wherein, in the cap portion, the determining unit is sealed so that the liquid does not reach an inside of the determining unit.

4. The printing apparatus according to claim 2,
wherein the determining unit is a circuit board configured by integrating a circuit and a board, and
the circuit board is accommodated in the cap portion so that the board side is opposed to the head.

5. The printing apparatus according to claim 1, wherein the determination of the nozzle that does not discharge liquid is performed on the basis of a signal indicating a change in electrostatic capacitance.

6. The printing apparatus according to claim 1,
wherein the head includes a nozzle plate having a plurality of the nozzles, and
the nozzle plate is grounded.

7. The printing apparatus according to claim 1, wherein the statement that the liquid is not normally discharged includes a case where an amount of the liquid discharged is smaller than a predetermined amount.

8. A discharge inspecting apparatus comprising:
a head which discharges liquid from a nozzle and is grounded;
a detection electrode which is opposed to the nozzle at a predetermined interval and is sealed by an insulating member;
a power source which ensures the detection electrode is at a predetermined potential;
a determining unit which detects a change in potential of the detecting electrode that is caused by the discharge of the liquid from the nozzle and determines a nozzle that does not normally discharge the liquid to the head on the basis of the change in potential of the detection electrode; and
a cap portion which abuts the head during non-printing and accommodates the detection electrode.

9. A discharge inspecting method using the printing apparatus according to claim 1, comprising:
discharging the liquid from the nozzle;
detecting a change in potential of the detecting electrode that is caused by the discharge of the liquid from the nozzle; and
determining a nozzle that does not normally discharge the liquid to the head on the basis of the change in potential of the detection electrode.
